(19) United States
(12) Patent Application Publication
(10) Pub. No.: US 2022/0000126 A1
(43) Pub. Date: Jan. 6, 2022

(54) Kayla's Delicious Pies

(71) Applicant: Louise Richardson, Cheektowaga, NY (US)

(72) Inventor: Louise Richardson, Cheektowaga, NY (US)

(21) Appl. No.: 15/929,692

(22) Filed: Jul. 2, 2020

(51) Int. Cl. A21D 13/38; A21D 13/31; A23L 19/10

(52) U.S. Cl. CPC A21D 13/38; A23V 2002/00; A23L 19/105; A21D 13/31

(57) ABSTRACT

The invention is a sweet potato pie infused with fresh fruit. I've never been a baker, but my faith is deep, and so I took a leap into the unknown. I was lead to use leftover fresh fruit and leftover sweet potatoes and infuse them together in order to create a new version of the sweet potato pie. I discovered that I can use all kinds of fruit to make my fruit infused sweet potato pies.

The ingredients of our pies are sweet potato, various fresh fruits, butter, eggs, vanilla extract, sugar, and flour, which are mixed together and poured into a 9-inch pie pan and baked in the oven at 350 degrees for approximately one hour.

I believe my pies will be sought after by many. I believe that my pies will be very successful because there isn't anything in the food industry like it currently. I want my pies to be known and liked by many throughout the world.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

My invention was given to me through a vision from God.

### BRIEF SUMMARY OF THE INVENTION

The invention is a sweet potato pie infused with fresh fruit. I've never been a baker, but my faith is deep, and so I took a leap into the unknown. I was lead to use leftover fresh fruit and leftover sweet potatoes and infuse them together in order to create a new version of the sweet potato pie. I discovered that I can use all kinds of fruit to make my fruit infused sweet potato pies.

### BRIEF DESCRIPTION OF THE SEVERAL VIEWS OF THE DRAWING

The drawing shows some of the ingredients that are used to create our pies.

### DETAILED DESCRIPTION OF THE INVENTION

The ingredients of our pies are sweet potato, various fresh fruits, butter, eggs, vanilla extract, sugar, and flour, which are mixed together and poured into a 9-inch pie pan and baked in the oven at 350 degrees for approximately one hour.

I believe my pies will be sought after by many. I believe that my pies will be very successful because there isn't anything in the food industry like it currently. I want my pies to be known and liked by many throughout the world.

1. I claim that my sweet potato fruit infused pies are unique. They have never been created before.
The ingredients of our pies are sweet potato, various fresh fruits, butter, eggs, vanilla extract, sugar, and flour, which are mixed together and poured into a 9-inch pie pan and baked in the oven at 350 degrees for approximately one hour.
I believe my pies will be sought after by many. I believe that my pies will be very successful because there isn't anything in the food industry like it currently. I want my pies to be known and liked by many throughout the world.
